(19) United States
(12) Patent Application Publication
(10) Pub. No.: US 2026/0145379 A1
(43) Pub. Date: May 28, 2026

(54) 3D PRINTING PROCESS AND 3D PRINTER

(71) Applicant: Akos Vida, Jacksonville, FL (US)

(72) Inventor: Akos Vida, Jacksonville, FL (US)

(21) Appl. No.: 19/223,297

(22) Filed: May 30, 2025

(30) Foreign Application Priority Data
Nov. 25, 2024 (HU) P 24 00534

(51) Int. Cl. B29C 64/118; B29C 64/209; B29C 64/232; B29C 64/393; B33Y 10/00; B33Y 30/00; B33Y 50/02

(52) U.S. Cl. CPC B29C 64/118; B29C 64/209; B29C 64/232; B29C 64/393; B33Y 10/00; B33Y 30/00; B33Y 50/02

(57) ABSTRACT

Systems and methods are provided for improving existing 3D FDM printing technologies. A 3D printing process and a 3D printer are also provided. The 3D printer provides stronger adhesion between the layers of printed parts than current printers. This enhancement increases the tensile strength of 3D printed components in the direction perpendicular to the layers.

### CROSS-REFERENCE TO RELATED APPLICATIONS

This application claims the benefit of Hungarian Application Serial No P 24 00534, filed Nov. 25, 2024, the complete disclosure of which is incorporated herein by reference for all purposes.

### TECHNICAL FIELD

This description generally relates to 3D printing processes and 3D printers.

### BACKGROUND

The most common 3D printing methods are based on Fused Deposition Modelling (FDM) technology, in which the print head melts a plastic filament and builds the 3D printed part layer by layer. This technology has become widespread due to its many advantages (e.g., affordable cost, high-quality prints).

Another advantage of FDM printers is their ability to print with a wide variety of plastics, which has led to their extensive use in the industrial sector (e.g., automotive manufacturing, space technology, aerospace, shipbuilding, etc.).

Despite their widespread use, FDM printers commonly suffer from weak interlayer bonding between the printed layers, leading to the anisotropic weakness of poor layer adhesion. Since 3D printed layers are deposited one after another, the deposited layer cools and solidifies by the time the next layer is extruded. This makes it difficult for strong bonds to form between layers, which can result in the printed layers separating under proportionally small forces. As a result, when designing with FDM printers, it is crucial to minimize loads that act perpendicular to the layer lines in the 3D printed part. This issue is particularly relevant in industries where the strength and weight of 3D printed components are critical.

Due to the significance of this structural weakness, several methods have already been developed to improve interlayer adhesion in 3D printed parts. One possible solution has been the development of 3D printers that heat the printing area to high temperatures. While this does promote better bonding between printed layers, it is particularly costly, as the 3D printer must be built using heat-resistant components. Additionally, printing at higher temperatures risks overheating parts, which can cause the degrading filament to emit hazardous gases.

The system described in U.S. Pat. No. 10,005,126 B2, among others, aims to improve adhesion between layers in 3D-printed components. The system includes an extruder with at least one nozzle, where the tip of the nozzle features an outlet opening. The width of the nozzle tip is equal to or greater than the width of the outlet opening. The system also includes a controller connected to the extruder, which is configured to apply a correction factor calculated based on the slope of the surface of the object being manufactured along the nozzle's path.

The correction factor for positive slopes differs from that for negative slopes. The extruder is configured to move the nozzle along a path in such a way that the printing material is deposited onto the sloped surface of the object. Thanks to the correction factor, the system eliminates variations in the thickness of the deposited material that would otherwise be caused by the slope relative to the path.

### SUMMARY

The following presents a simplified summary of the claimed subject matter in order to provide a basic understanding of some aspects of the claimed subject matter. This summary is not an extensive overview of the claimed subject matter. It is intended to neither identify critical elements of the claimed subject matter nor delineate the scope of the claimed subject matter. Its sole purpose is to present some concepts of the claimed subject matter in a simplified form as a prelude to the more detailed description that is presented later.

Systems and methods are provided for improving existing 3D FDM printing technologies. A 3D printing process and a 3D printer are also provided. The 3D printer provides stronger adhesion between the layers of printed parts than current printers. This enhancement increases the tensile strength of 3D printed components in the direction perpendicular to the layers.

In one aspect, a method of 3D printing an object comprises moving a nozzle of a 3D printer along a linear path substantially parallel to the object from a first position to a second position, dispensing printing material from the nozzle between the first and second positions and moving the nozzle in a first direction transverse to the linear path at the second position.

In embodiments, the first direction is at an angle relative to the linear path of between about 10 degrees and 170 degrees, or between about 25 degrees and 155 degrees, or between about 40 degrees and about 140 degrees.

In embodiments, the first direction is substantially perpendicular to the linear path.

In embodiments, the method further comprises ceasing the dispensing of printing materials when the nozzle is moved in the first direction.

In embodiments, the method further comprises moving the nozzle in a second direction transverse to the linear path. In some embodiments, the second direction is opposite the first direction. In other embodiments, the second direction is at an angle relative to the linear path of between 10 degrees and 170 degrees or between about 25 degrees and 155 degrees, or between about 40 degrees and about 140 degrees.

In embodiments, the method further comprises ceasing the dispensing of printing materials when the nozzle is moved in the second direction.

In embodiments, the first direction is towards the object and the second direction is away from the object.

In embodiments, the object comprises one or more layers and the nozzle is moved in the first direction until the nozzle contacts or is embedded into one or more of the layers. In an exemplary embodiment, the method further comprises transferring heat from the nozzle to said one of the layers. For example, the layer may comprise the top layer of the object.

In embodiments, the first position and the second position are offset relative to each other in a plane parallel to the object.

In embodiments, the first position and the second position are offset relative to each other in a plane perpendicular to the object.

In another aspect, a 3D printer comprises a housing; a nozzle having an opening coupled to the housing and configured to feed filament through the opening; a motion component configured to move the nozzle; a processor; and a data storage unit or a non-transitory computer-readable medium coupled to the motion component. The data storage unit or the non-transitory computer-readable medium stores instructions that, when executed by the processor, causes the nozzle to move along a linear path substantially parallel to an object from a first position to a second position; dispense printing material onto the object between the first and second positions; and move in a first direction transverse to the linear path at the second position.

In embodiments, the first direction is at an angle relative to the linear path of between about 10 degrees and 170 degrees, or between about 25 degrees and 155 degrees, or between about 40 degrees and about 140 degrees.

In embodiments, the first direction is substantially perpendicular to the linear path.

In embodiments, the data storage unit stores instructions that, when executed by the processor: ceases the dispensing of printing materials when the nozzle is moved in the first direction.

In embodiments, the data storage unit stores instructions that, when executed by the processor, causes the nozzle to move in a second direction transverse to the linear path In some embodiments, the second direction is opposite the first direction. In other embodiments, the second direction is at an angle relative to the linear path of between 10 degrees and 170 degrees or between about 25 degrees and 155 degrees, or between about 40 degrees and about 140 degrees.

In embodiments, the the data storage unit stores instructions that, when executed by the processor, ceases the dispensing of printing materials as the nozzle is moved in the second direction.

In embodiments, the first direction is towards the object and the second direction is away from the object.

In embodiments, the object comprises one or more layers and the nozzle is moved in the first direction until the nozzle contacts or is embedded into one or more of the layers. In an exemplary embodiment, the method further comprises transferring heat from the nozzle to said one of the layers. For example, the layer may comprise the top layer of the object.

In embodiments, the first position and the second position are offset relative to each other in a plane parallel to the object.

In embodiments, the first position and the second position are offset relative to each other in a plane perpendicular to the object.

In embodiments the motion component may comprise one or more rails or rods for guiding movement of the nozzle. The motion component may further comprise a motor, such as a stepper motor, for driving movement of the nozzle. In an exemplary embodiment, the motion component further comprises a belt or leadscrew for transferring motion to the nozzle.

In embodiments, the 3D printer further comprises a print bed with a heating element and a surface material, such as glass, PEI, magnetic sheets or the like.

The recitation herein of desirable objects which are met by various embodiments of the present description is not meant to imply or suggest that any or all of these objects are present as essential features, either individually or collectively, in the most general embodiment of the present description or any of its more specific embodiments.

### BRIEF DESCRIPTION OF THE DRAWINGS

The accompanying drawings, which are incorporated in and constitute a part of this specification, illustrate several embodiments of the disclosure and together with the description, explain the principles of the disclosure.

FIG. 1 schematically illustrates the layer deposition of a conventional 3D printer;

FIG. 2 schematically illustrates the layer deposition of the 3D printer described herein;

FIG. 3 shows the failure of an “I”-shaped component produced by conventional 3D printing and by the 3D printing process described herein during a load test; and

FIG. 4 schematically illustrates the layer deposition of a 3D printer described herein according to another embodiment.

### DETAILED DESCRIPTION OF THE EMBODIMENTS

This description illustrates exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

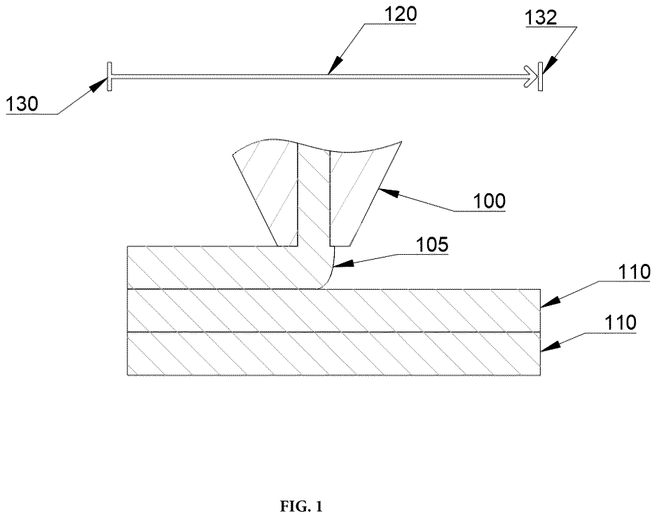

As shown in FIG. 1, in conventional 3D printers, the nozzle 100 that dispenses the printing material moves along a linear path 120 parallel to the plane of the printed layers 110. It travels from one edge point 130 of the given printing slice to the opposite edge point 132, continuously dispensing the printing material 105 onto the topmost layer 110 of the object being printed.

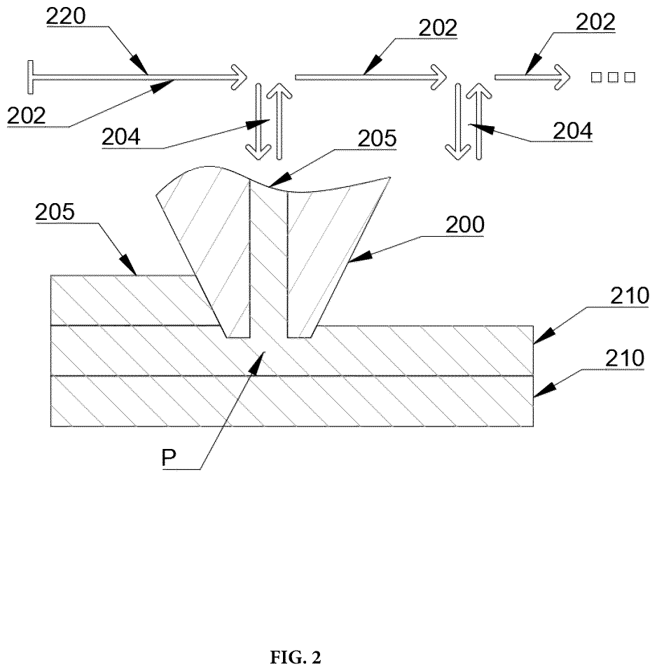

FIG. 2 schematically illustrates the path of the nozzle 220 during the execution of the 3D printing process. The nozzle 200 of the 3D printer is moved such that it travels parallel to the already printed layers 210 within predetermined printing intervals 202, continuously dispensing the printing material 205 onto the topmost layer 210 of the object being printed.

At the end of each printing interval 202, the nozzle 200 is displaced downward in a vertical direction by a predetermined distance 204, then retracted upward to the appropriate height corresponding to the horizontal sections of the printing path 220, and continues moving horizontally through the next printing interval 202 to its further endpoint.

The horizontal movement of the nozzle 200 corresponds to the movement shown in FIG. 1, so this phase is not depicted separately in FIG. 2. FIG. 2 shows the nozzle 200 at the bottom dead point of its transverse deflection—that is, the lowest point of its motion perpendicular to the direction of travel.

During the transverse movement of the nozzle 200, the dispensing of the printing material 205 is paused. In other words, at the endpoint of a given printing interval 202, the extrusion of the printing material 205 from the nozzle 200 is stopped. The nozzle 200 is then moved downward and subsequently upward by the distance 204. The dispensing of the printing material 205 resumes only when the nozzle 200 starts moving from the starting point of the next horizontal printing interval 202.

The 3D printing process thus consists of the following steps S1-S6:
Step S1: Move the nozzle 200 of the 3D printer along a predetermined straight path 220, parallel to the topmost layer 210 of the object to be printed.
Step S2: While the nozzle 200 is moving, dispense the printing material 205 from the nozzle onto the topmost layer 210 of the object.
Step S3: When a predetermined distance (a printing interval 202) along the straight printing path 220 is reached, stop the extrusion of the printing material 205.
Step S4: After stopping the dispensing of the printing material 205, move the nozzle 200 perpendicularly to its direction of travel by a predetermined distance 204 toward the object, thereby pressing the tip of the nozzle 200 into the topmost layer 210 of the object.
Step S5: Move the nozzle 200 back in the opposite perpendicular direction to the travel level of the printing path 220, thereby retracting the tip of the nozzle 200 from the topmost layer 210 of the object.
Step S6: Resume the dispensing of the printing material 205 and continue moving the nozzle 200 along the straight printing path 220 to the endpoint of the next printing interval 202 (corresponding to Step S1).

By moving the nozzle 200 downward, it is pressed into the already deposited topmost layer 210, effectively “pinching” this top layer and potentially one or more additional layers 210 beneath it. This pinching zone is labeled as P in FIG. 2.

Due to the downward motion, the one or more topmost layers 210 that come into contact with the nozzle 200 are heated to the nozzle's temperature. As a result, the currently deposited layer and the previously deposited topmost layers 210 fuse more effectively, leading to stronger interlayer adhesion between the layers 210.

The length of the printing interval 202 and the vertical distance 204 depend on the type of printing material 205 and other printing parameters. In a preferred embodiment of the process, during layer deposition, the start and end points of the printing intervals may be offset from one another in planes parallel to the layers and/or in the direction perpendicular to the layers. As a result, the “pinching” zones of the layers are spatially distributed evenly, which further increases the load-bearing capacity of the printed component.

The programmed horizontal and vertical movement of the nozzle 200 ensures layer continuity and proper layer thickness.

The 3D printer includes a control program stored in its data storage unit, which moves the nozzle of the 3D printer along the printing path as described above (see FIG. 2).

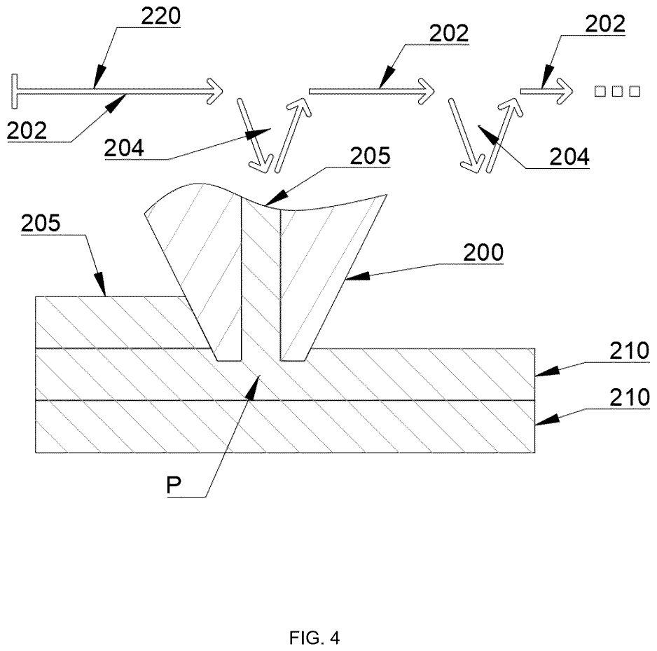

FIG. 4 illustrates another embodiment of the 3D printer and process described herein. In this embodiment, the nozzle 200 of the 3D printer is moved such that it travels parallel to the already printed layers 210 within predetermined printing intervals 202, continuously dispensing the printing material 205 onto the topmost layer 210 of the object being printed. At the end of each printing interval 202, the nozzle 200 is displaced downward in a transverse direction by a predetermined distance 204, then retracted upward to the appropriate height corresponding to the horizontal sections of the printing path 220 and continues moving horizontally through the next printing interval 202 to its further endpoint. The nozzle may be moved at an angle of relative to the linear path or the object of between 10 degrees and 170 degrees or between about 25 degrees and 155 degrees, or between about 40 degrees and about 140 degrees

The movement of the nozzle 200 corresponds to the movement shown in FIG. 4. In an exemplary embodiment, the down-then-up movement is at a slight angle (essentially moving through the path of a V into the material at discrete intervals), which allows the printhead to retain some of its momentum in the x-y plane.

During the transverse movement of the nozzle 200, the dispensing of the printing material 205 is paused. In other words, at the endpoint of a given printing interval 202, the extrusion of the printing material 205 from the nozzle 200 is stopped. The nozzle 200 is then moved downward and subsequently upward by the distance 204. The dispensing of the printing material 205 resumes only when the nozzle 200 starts moving from the starting point of the next horizontal printing interval 202.

### Test Results

During testing, ISO 527 samples were printed using both conventional 3D printing and the 3D printing technique described herein. After printing, the ISO 527 components were pulled apart in a direction perpendicular to the 3D-printed layers using a universal test machine. During testing, ISO 179-1 samples were also printed using both conventional 3D printing and the 3D printing technique described herein. After printing, the ISO 179 test components were broken with a Charpy impact test machine.

Various plastic filaments from different manufacturers were used for printing. The tested materials included: polylactic acid (PLA), polyethylene terephthalate glycol (PETG), polycarbonate (PC), a combination of polylactic acid and thermoplastic polyurethane (TPU) layers, foaming agent-infused polylactic acid (LW-PLA), polyamide (Nylon PA12), and PETG with a carbon-fiber additive.

During printing, the movement of the printer nozzle for parts manufactured using the method described herein was controlled to perform a vertical (up-and-down) movement of 0.45 mm after every 1 mm of horizontal travel. However, these values can be altered, even within the creation of a single part. During these vertical movements, no additional filament was deposited by the printer, as these were intermediate, so-called “travel” moves.

To standardize the testing conditions and compensate for the slower print speed introduced by the method described herein, the print speed for parts produced using conventional techniques was also proportionally reduced.

A total of 123 tensile strength and 158 impact strength measurements were performed.

The results of the tests are summarized in the following Tables 1-3.

TABLE 1-3

| | % ratio of tensile |
|---|---|
| | strength of samples |
| Name of plastic | (technique/standard) |
| PLA Type 1 | 81.5 |
| PLA Type 2 | 131.4 |
| PLA Type 3 | 161.7 |
| PETG Type 1 | 113.5 |
| PETG Type 2 | 101.2 |
| Carbon Fiber PETG | 137.9 |
| LW-PLA | 339.1 |
| Nylon PA12 | 116.1 |
| TPU-PLA Combination | 211.3 |
| Polycarbonate | 129.7 |
| Average of all: | 152.34 |

| | % ratio of maximum |
|---|---|
| | deformation of samples |
| Name of plastic | (technique/standard) |
| PLA Type 1 | 102.9 |
| PLA Type 2 | 146.7 |
| PLA Type 3 | 216.5 |
| PETG Type 1 | 155.6 |
| PETG Type 2 | 157.7 |
| Carbon Fiber PETG | 170 |
| LW-PLA | 147 |
| Nylon PA12 | 132.3 |
| TPU-PLA Combination | 192 |
| Polycarbonate | 218.9 |
| Average of all: | 163.96 |

| | % ratio of impact |
|---|---|
| | strength of samples |
| Name of plastic | (technique/standard) |
| PLA Type 1 | 132.9 |
| PLA Type 2 | 145 |
| PLA Type 3 | 200.3 |
| PETG Type 1 | 126.8 |
| PETG Type 2 | 215 |
| Carbon Fiber PETG | 261.1 |
| LW-PLA | 220.3 |
| Nylon PA12 | 183.3 |
| TPU-PLA Combination | 179.3 |
| Polycarbonate | 236.2 |
| Average of all: | 190.02 |

As shown in Tables 1-3, the test components produced with the 3D printing process described herein generally demonstrated significantly higher tensile strength, maximum deformation before failure, and impact strength than those printed using conventional methods.

In some cases, the increase in tensile strength reached as high as +239% (see LW-PLA for tensile strength). For all test components, the average increase in tensile strength was 52%, the average increase in the maximum deformation before failure was 64%, and the average increase in impact strength was 90%.

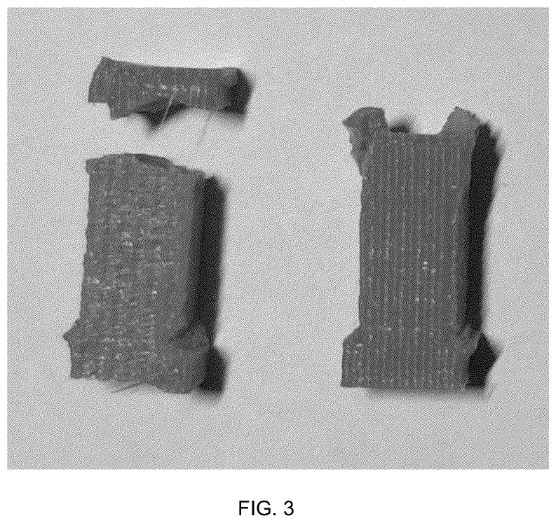

FIG. 3 shows the failure of an “I”-shaped component made of PETG during the above-mentioned load test, comparing a part printed using conventional 3D printing (left side of the figure) with one printed using the method described herein (right side).

On the left, the conventionally printed “I”-shaped part separated along the print layers at its upper end, indicating poor interlayer adhesion. In contrast, on the right, the part printed using the method described herein did not delaminate along the layers. Instead, only the edges at the upper end of the part were deformed (damaged) in the tensile testing machine, demonstrating significantly improved layer bonding.

An advantage of the 3D printing process described herein is that the increased adhesion between layers—and the resulting higher tensile strength in the direction perpendicular to the layers—allows the same components to be produced using less printing material compared to conventional 3D printing. This leads to a reduction in the weight of the components, and consequently a decrease in plastic usage and waste generation in 3D printing.

Moreover, with identical dimensions, components printed using the method described herein can possess greater load-bearing capacity, which is particularly beneficial in industries such as aerospace, space technology, and automotive manufacturing.

A further advantage of the 3D printing process described herein is that it can be applied to virtually any FDM-type 3D printer through appropriate reprogramming. This involves modifying the nozzle's printing path and the material deposition sequence, meaning no specialized hardware is required-only software-level adjustments are necessary.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

What is claimed is:

1. A method of 3D printing an object comprising:
moving a nozzle of a 3D printer along a linear path substantially parallel to the object from a first position to a second position;
dispensing printing material from the nozzle between the first and second positions; and
moving the nozzle in a first direction transverse to the linear path at the second position.

2. The method of claim 1, wherein the first direction is at an angle relative to the linear path of between 10 degrees and 170 degrees.

3. The method of claim 1, wherein the first direction is substantially perpendicular to the linear path.

4. The method of claim 1, further comprising ceasing the dispensing of printing materials as the nozzle is moved in the first direction.

5. The method of claim 1, further comprising moving the nozzle in a second direction transverse to the linear path.

6. The method of claim 5, wherein the second direction is opposite the first direction.

7. The method of claim 5, wherein the second direction is at an angle relative to the linear path of between 10 degrees and 170 degrees.

8. The method of claim 5, further comprising ceasing the dispensing of printing materials as the nozzle is moved in the second direction.

9. The method of claim 6, wherein the first direction is towards the object and the second direction is away from the object.

10. The method of claim 1, wherein the object comprises one or more layers and the nozzle is moved in the first direction until the nozzle contacts or is embedded into one or more of the layers.

11. The method of claim 7, further comprising transferring heat from the nozzle to said one of the layers.

12. The method of claim 1, wherein the first position and the second position are offset relative to each other in a plane parallel to the object.

13. The method of claim 1, wherein the first position and the second position are offset relative to each other in a plane perpendicular to the object.

14. A 3D printer comprising:
a housing;
a nozzle having an opening coupled to the housing and configured to feed filament through the opening;
a motion component configured to move the nozzle;
a processor; and
a data storage unit coupled to the motion component and storing instructions that, when executed by the processor, causes the nozzle to:
move along a linear path substantially parallel to an object from a first position to a second position;
dispense printing material onto the object between the first and second positions; and
move in a first direction transverse to the linear path at the second position.

15. The 3D printer of claim 14, wherein the first direction is at an angle relative to the linear path of between 10 degrees and 170 degrees.

16. The 3D printer of claim 14, wherein the first direction is substantially perpendicular to the linear path.

17. The 3D printer of claim 14, wherein the data storage unit stores instructions that, when executed by the processor, ceases the dispensing of printing materials as the nozzle is moved in the first direction.

18. The 3D printer of claim 14, wherein the data storage unit stores instructions that, when executed by the processor, causes the nozzle to move in a second direction transverse to the linear path.

19. The 3D printer of claim 14, wherein the object comprises one or more layers and the nozzle is moved in the first direction until the nozzle contacts or is embedded into one or more of the layers.

20. The 3D printer of claim 19, further comprising transferring heat from the nozzle to said one of the layers.
